(19) United States
(12) Patent Application Publication
(10) Pub. No.: US 2026/0310547 A1
(43) Pub. Date: Oct. 8, 2026

(54) COMMAND ADDRESS ERROR CONTROL

(71) Applicant: Micron Technology, Inc., Boise, ID (US)

(72) Inventors: Scott E. Schaefer, Boise, ID (US); Frank F. Ross, Boise, ID (US); Anthony D. Veches, Boise, ID (US); Sujeet V. Ayyapureddi, Boise, ID (US); Randall J. Rooney, Boise, ID (US); Matthew A. Prather, Boise, ID (US); Navid Lashkarian, Pleasanton, CA (US)

(21) Appl. No.: 19/630,159

(22) Filed: Mar. 26, 2026

Related U.S. Application Data
(60) Provisional application No. 63/782,452, filed on Apr. 2, 2025.

(51) Int. Cl. G06F 11/10

(52) U.S. Cl. CPC G06F 11/1016; G06F 11/1048

(57) ABSTRACT

Methods, systems, and devices for command address error control are described. The memory system may receive command address (CA) information and error control information associated with the CA information. The memory system may perform an error control operation on the CA information using the error control information by determining whether the CA information includes one or more errors using the error control information and perform an operation associated with the CA information based on performing the error control operation.

### CROSS REFERENCE

The present Application for Patent claims priority to U.S. Patent Application No. 63/782,452 by Schaefer et al., entitled “COMMAND ADDRESS ERROR CONTROL,” filed Apr. 02, 2025, which is assigned to the assignee hereof, and which is expressly incorporated by reference in its entirety herein.

### TECHNICAL FIELD

The following relates to one or more systems for memory, including command address (CA) error control.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports command address (CA) error control in accordance with examples as disclosed herein.

FIG. 2 shows an example of a system that supports CA error control in accordance with examples as disclosed herein.

FIG. 3 shows a block diagram of a memory system that supports CA error control in accordance with examples as disclosed herein.

FIG. 4 shows a flowchart illustrating a method or methods that support CA error control in accordance with examples as disclosed herein.

### DETAILED DESCRIPTION

A host system and a memory system may perform an access operation to read data from the memory system or write data to the memory system. To perform the access operation, the host system may transmit command address (CA) information to the memory system. The CA information may include an indication of the access command as well as an indication of a memory address of the memory system to apply the access command to. In some examples, the CA information may include one or more errors. Errors in the CA information may negatively impact the access operation. For example, an error related to the memory address may cause the memory system to access wrong data.

As described herein, the memory system and the host system may support error control for the CA information. The host system may transmit, to the memory system, the CA information and error control information associated with the CA information. Upon receiving the CA information and the error control information, the memory system may perform an error control operation on the CA information using the error control information by determining whether the CA information includes one or more errors. Further, the memory system may perform an operation associated with the CA information based on performing the error control operation. Using the methods as described herein the memory system may detect errors in the CA information which may allow the memory system to avoid accessing wrong data. among other advantages.

In addition to applicability in memory systems as described herein, techniques for CA error control may be generally implemented to support increased connectivity of electronic systems. As the use of systems relying on interconnected electronic devices increases, the connectivity of these electronic devices becomes an increasingly relevant factor for the operations of the system. For example, delays associated with signals communicated between devices may become increasingly relevant as critical systems come to rely more on connectivity, as a system uses larger quantities of interconnected devices, or if the quantity and the complexity of signals communicated between devices increases. Implementing the techniques described herein may support techniques for increased connectivity in electronic systems by improving data transfer between devices, improving the reliability of data transferred between devices, among other benefits.

Features of the disclosure are illustrated and described in the context of systems and architectures. Features of the disclosure are further illustrated and described in the context of component diagrams and flowcharts.

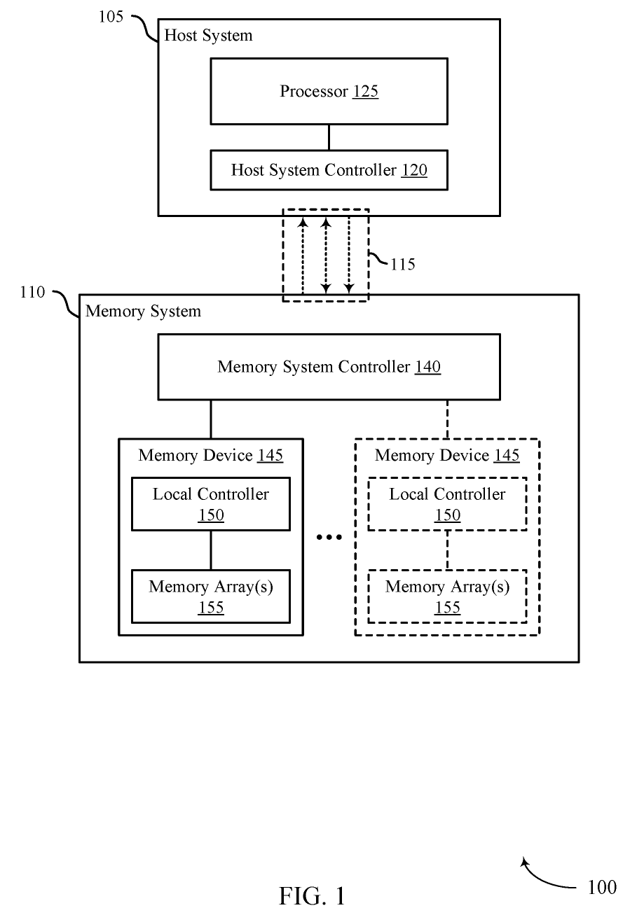

FIG. 1 shows an example of a system 100 that supports CA error control in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

A host system 105 may include one or more components (e.g., circuitry, processing circuitry, application processing circuitry, one or more processing components) that use memory to execute processes (e.g., applications, functions, computations), any one or more of which may be referred to as or be included in a processor 125 (e.g., an application processor). A processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. A processor 125 may be an example of a central processing unit (CPU), a graphics processing unit (GPU), a general-purpose GPU (GPGPU), or an SoC or a component thereof, among other examples.

A host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating a memory system 110, such as write commands, read commands, configuration signaling or other operational signaling. In some examples, a host system controller 120, or associated functions described herein, may be implemented by or be part of a processor 125. For example, a host system controller 120 may be hardware, instructions (e.g., software, firmware), or a combination thereof implemented by a processor 125 or other component of a host system 105. In various examples, a host system 105 or a host system controller 120 may be referred to as a host.

A memory system 110 provides physical memory locations (e.g., addresses) that may be used or referenced by the system 100. A memory system 110 may include a memory system controller 140 and one or more memory devices 145 (e.g., memory packages, memory dies, portions of a memory die) operable to store data. A memory system 110 may be configurable for operations with different types of host systems 105, and may respond to commands from the host system 105 (e.g., from a host system controller 120). For example, a memory system 110 (e.g., a memory system controller 140) may receive a write command indicating that the memory system 110 is to store data received from a host system 105, or receive a read command indicating that the memory system 110 is to provide data stored in a memory device 145 to a host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of a memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with a host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 (e.g., a logic controller, an interface controller, one or more processors) and one or more memory arrays 155. A memory array 155 may be a collection of memory cells (e.g., a two-dimensional array, a three-dimensional array, an array of one or more semiconductor components), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. In some implementations, at least the channels 115 between a host system 105 and a memory system 110 may include or be referred to as a host interface (e.g., a physical host interface). To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

A CA channel may be operable to communicate commands between the host system 105 and the memory system 110, including control information associated with the commands (e.g., address information, configuration information). Commands carried by a CA channel may include a write command with an address for data to be written to the memory system 110 or a read command with an address of data to be read from the memory system 110.

In some examples, the system 100 may support error control for the CA channel. For example, the host system 105 may transmit, to the memory system 110, CA information (e.g., the control information associated with the commands) and error control information associated with the CA information. Upon receiving the CA information and the error control information, the memory system 110 may perform an error control operation on the CA information using the error control information by determining whether the CA information includes one or more errors. Further, the memory system 110 may perform an operation associated with the CA information based on performing the error control operation. Using the methods as described herein the memory system 110 may detect errors in the CA information which may allow the memory system 110 to avoid accessing wrong data, among other advantages.

A clock signal channel may be operable to communicate one or more clock signals between the host system 105 and the memory system 110. Clock signals may oscillate between a high state and a low state, and may support coordination (e.g., in time) between operations of the host system 105 and the memory system 110. In some examples, a clock signal may provide a timing reference for operations of the memory system 110. A clock signal may be referred to as a control clock signal, a command clock signal, or a system clock signal. A system clock signal may be generated by a system clock, which may include one or more hardware components (e.g., oscillators, crystals, logic gates, transistors).

A data channel (e.g., a DQ channel) may be operable to communicate (e.g., bidirectionally) information (e.g., data, control information) between the host system 105 and the memory system 110. For example, a data channel may communicate information from the host system 105 to be written to the memory system 110, or information read from the memory system 110 to the host system 105. In some examples, channels 115 may include one or more error detection code (EDC) channels. An EDC channel may be operable to communicate error detection signals, such as checksums or parity bits, which may accompany information conveyed over a data channel.

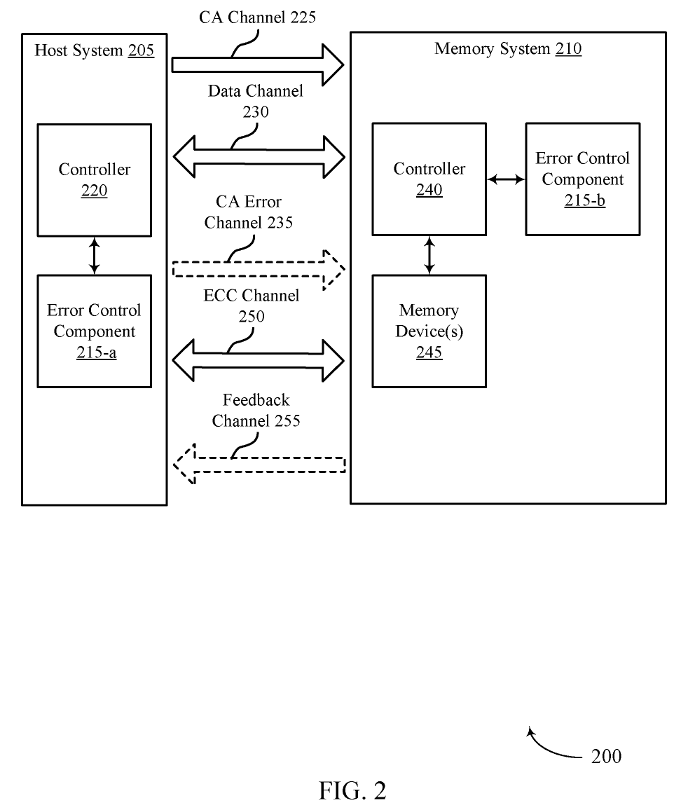

FIG. 2 shows an example of a system 200 that supports CA error control in accordance with examples as disclosed herein. In some examples, the system 200 may implement aspects of the system 200. For example, the system 200 may include a host system 205, a controller 220, a memory system 210, a controller 240, and a memory device 245 which may be examples of the host system 105, the host system controller 120, the memory system 110, the memory system controller 140, and the memory device 145, respectively, as described with reference to FIG. 1.

In some examples, the host system 205 and the memory system 210 may exchange data between one another. For example, during a write operation, the host system 205 (or the controller 220) may transmit data to the memory system 210 (or the controller 240) for storage at the memory system 210 (e.g., storage at one or more memory devices 245 of the memory system 210). As another example, during a read operation, the memory system 210 (or the controller 240) may transmit data stored at the memory system 210 to the host system 205 (or the controller 220). In some examples, the host system 205 and the memory system 210 may exchange the data over a channel allocated for data transfer. For example, the system 200 may include a data channel 230 that includes one or more pins configured to transfer data between the host system 205 and the memory system 210.

In some examples, the system 200 may implement techniques that allow the system 200 to correct or detect errors that may occur in the data during data transfer between the host system 205 and the memory system 210. For example, during the write operation, the host system 205 may generate a first set of parity bits along with the data and transmit the data as well as the first set of parity bits to the memory system 210. In response to receiving the data, the memory system 210 may generate a second set of parity bits and compare the first set of parity bits to the second set of parity bits. If the first set of parity bits and the second set of parity bits match, the memory system 210 may determine that the data is free from errors and store the data at one or more memory devices 245 of the memory system. Alternatively, if the first set of parity bits and the second set of parity bits do not match, the memory system may detect that the data includes one or more errors.

Similar operations may be performed during the read operation. For example, during the read operation, the memory system 210 may generate a third set of parity bits along with the data and transmit the data as well as the third set of parity bits to the host system 205 in response to receiving a read command for the data. Upon receiving the data, the host system 205 may generate a fourth set of parity bits and compare the third set of parity bits to the fourth set of parity bits. If the third set of parity bits and the fourth set of parity bits match, the host system 205 may determine that the data is free from errors and perform one or more operations associated with the data. Alternatively, if the third set of parity bits and the fourth set of parity bits do not match, the host system 205 may detect that the data includes one or more errors. In some examples, In some examples, the host system 205 and the memory system 210 may exchange the parity (e.g., the first set of parity bits or the third set of parity bits) over a channel allocated for error control of the data. For example, the system 200 may include an ECC channel 250 that includes one or more pins configured to transfer the parity between the host system 205 and the memory system 210.

In some examples, the host system 205 may convey information related to the read operation or the write operation to the memory system 210 using a CA channel 225. The CA channel 225 may be an example of a uni-directional channel allocated for CA information. During the write command, the host system 205 may transmit the write command and an address associated with the write command to the memory system 210 using the CA channel 225. The address associated with the write command may correspond to a physical address of the memory system 210 that the data may be written to. Similarly, during the read command, the host system 205 may transmit the read command and an address associated with the read command to the memory system 210. The address associated with the read command may correspond to a physical address of the memory system 210 that the data may be read from.

In some examples, errors may occur in the CA information during transmission of the CA information using the CA channel 225. As such, the memory system 210 may receive CA information that includes one or more errors. If one or more errors in the CA information occur, the memory system 210 may potentially access a wrong physical memory address of the memory system 210 as part of the access operation (e.g., the read operation or the write operation). Alternatively, if one or more errors in the CA information occur, the memory system 210 may fail to perform the respective access operation. Thus, it may be beneficial for the system 200 to implement techniques that may allow the system 200 to correct or detect errors that may occur in the CA information and block some access operations (e.g., when the error control operation identifies one or more errors).

As described herein, the system 200 may support CA error control. In some examples, the memory system 210 may receive CA information from the host system 205 using the CA channel 225. The CA information may include an indication of an access command (e.g., a write command or a read command) and an address associated with the access command. Upon receiving the CA information, the memory system 210 may perform an error control operation on the CA information to determine whether the CA information includes one or more errors.

In some examples, the host system 205 may generate error information associated with the CA information and transmit the error information associated with the CA information along with the CA information to the memory system 210. Upon receiving the CA information and the error information, the memory system 210 may utilize the error information to determine whether the CA information comprises the one or more errors.

In some examples, the host system 205 may generate the error information based on the CA information. For example, the host system 205 may input the CA information in the error control component 215-a and the error control component 215-a may output a fifth set of parity bits that includes one or more parity bits. In such example, upon receiving the CA information, the memory system 210 may generate second error information based on the received CA information. For example, the memory system 210 may input the received CA information in the error control component 215-b and the error control component 215-b may output a sixth set of parity bits that includes one or more parity bits. Further, the error control component 215-b may compare error control information to the second error control information to detect whether the CA information comprises the one or more errors.

Alternatively, the host system 205 may generate the error information based on both the CA information and data associated with the CA information (e.g., data transferred between the memory system 210 and the host system 205 as part of the access operation). For example, the host system 205 may input the CA information and the data into the error control component 215-a and the error control component 215-a may output a seventh set of parity bits including one or more parity bits. In such example, upon receiving the CA information, the memory system 210 may generate third error information based on the received CA information and the received data. For example, the memory system 210 may input the received CA information and the received data in the error control component 215-b and the error control component 215-b may output an eighth set of parity bits that includes one or more parity bits. Further, the error control component 215-b may compare error control information to the third error control information to detect whether the CA information or the data comprises one or more errors.

In some examples, the memory system 210 may determine that the CA information is free from errors (e.g., does not include one or more errors). The memory system 210 may determine that the CA information is free from errors if the memory system 210 determines that the error information received from the host system 205 along with the CA information and the error information generated by memory system 210 (e.g., the second error information or the third error information) match.

Alternatively, the memory system 210 may determine that the CA information includes one or more errors. In some examples, the memory system 210 may determine that the CA information includes one or more errors if the memory system 210 determines that the error information received from the host system 205 along with the CA information and the error information generated by memory system 210 (e.g., the second error information or the third error information) do not match. In some examples, if the memory system 210 determines that CA information includes one or more errors, the memory system 210 may have a capability to correct the one or more errors (e.g., single error correction (SEC) or multi-error correction (MEC)). In such example, the error information may include an ECC codeword and the error control components 215 may include ECC engines. In some cases, the memory system 210 may have a capability detect and/or correct one or more errors. For example, the error control operation may be capable of detecting one or more errors (e.g., single error detection (SED), double-error detection (DED), multi-error detection (MED)) and/or correcting one or more errors (e.g., SEC, double-error correction (DEC), MEC). The error control operation may be an example of a SEC operation, a SECDED operation, a SECMED operation, MECMED operation, and/or a DECMED operation.

In some examples, if the memory system 210 determines the CA information is free of errors, the memory system 210 (or the controller 240) may perform an operation associated with CA information. Alternatively, if the memory system 210 determines that the CA information includes one or more errors (or uncorrectable errors), the memory system 210 may refrain from performing the operation associated with the CA information. Alternatively or additionally, if the memory system 210 determines that the CA information includes one or more errors, the memory system 210 may transmit feedback information to the host system 205. In some examples, the feedback information may indicate that the CA information includes the one or more errors. As shown in FIG. 2, the system 200 may include a feedback channel 255 that includes one or more pins configured to communicate the feedback information from the memory system 210 to the host system 205. In response to the feedback information, the host system 205 may retry the access operation. That is, the host system 205 may retransmit the CA information to the memory system 210. In some cases, the retransmitted CA information may also include retransmitting the error information. Retransmitting the error information may include retransmitting the same error information. However, in some cases, retransmitting the error information may include transmitting error control information with additional error detection and/or error correction capabilities. In such examples, the memory system 210 may use the updated error control information on the retransmitted CA information to improve a likelihood that the CA information is received and/or decoded properly.

In some examples, host system 205 and the memory system 210 may communicate the error information associated with the CA information via a channel of the system 200. In one example, the system 200 may include a channel specifically configured to communicate the error information associated with the CA information. For example, the system 200 may include a CA error channel 235 that includes one or more pins configured to communicate the error control information associated with the CA information from the host system 205 to the memory system 210.

Alternatively, the host system 205 and the memory system 210 may repurpose an existing channel of the system 200 to communicate the error control information associated with the CA information. For example, the system 200 may include an ECC channel 250 configured to communicate ECC codewords associated with the data between the host system 205 and the memory system 210. The host system 205 and the memory system 210 may repurpose the ECC channel 250 to communicate the error control information associated with the CA information. Alternatively, the host system 205 may transmit the error control information to the memory system 210 along with the data via the one or more pins of the data channel 230.

Using the methods as described herein may allow the system to detect and potentially correct errors in CA information communicated via the CA channel 225. Correcting or detecting such errors in the CA information may decrease incorrect memory accesses. That is, a quantity of times that the memory system 210 may access a wrong memory address in response to an access command may be decreased or reduced to zero using the methods as described herein when compared to other methods.

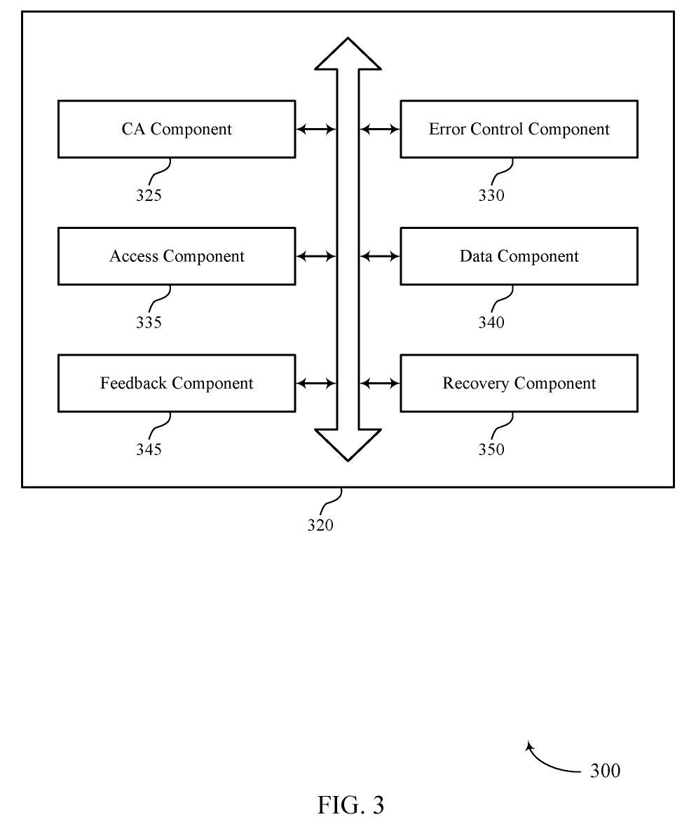

FIG. 3 shows a block diagram 300 of a memory system 320 that supports CA error control in accordance with examples as disclosed herein. The memory system 320 may be an example of aspects of a memory system as described with reference to FIGS. 1 through 2. The memory system 320, or various components thereof, may be an example of means for performing various aspects of CA error control as described herein. For example, the memory system 320 may include a CA component 325, an error control component 330, an access component 335, a data component 340, a feedback component 345, a recovery component 350, or any combination thereof. Each of these components, or components of subcomponents thereof (e.g., one or more processors, one or more memories), may communicate, directly or indirectly, with one another (e.g., via one or more buses).

The CA component 325 may be configured as or otherwise support a means for receiving CA information and error control information associated with the CA information. The error control component 330 may be configured as or otherwise support a means for performing an error control operation on the CA information using the error control information by determining whether the CA information includes one or more errors using the error control information. The access component 335 may be configured as or otherwise support a means for performing an operation associated with the CA information based at least in part on performing the error control operation.

In some examples, to support receiving the CA information, the CA component 325 may be configured as or otherwise support a means for receiving the CA information via one or more CA pins of the memory system. In some examples, to support receiving the CA information, the error control component 330 may be configured as or otherwise support a means for receiving the error control information via one or more pins of the memory system configured for receiving the error control information associated with the CA information.

In some examples, to support receiving the CA information, the data component 340 may be configured as or otherwise support a means for receiving data associated with the CA information via one or more data pins of the memory system. In some examples, to support receiving the CA information, the error control component 330 may be configured as or otherwise support a means for receiving second error control information associated with the data via one or more error control pins of the memory system.

In some examples, to support performing the error control operation, the error control component 330 may be configured as or otherwise support a means for generating a codeword including the CA information and the data. In some examples, to support performing the error control operation, the error control component 330 may be configured as or otherwise support a means for generating third error control information associated with the CA information and the data. In some examples, to determine whether the CA information, the error control component 330 may be configured as or otherwise support a means for comparing the third error control information with the error control information and the second error control information and the error control component 330 may be configured as or otherwise support a means for determining whether the third error control information matches the error control information and the second error control information, where determining that the CA information includes the one or more errors is based at least in part on determining that the third error control information does not match the error control information and the second error control information.

In some examples, to support receiving the CA information, the CA component 325 may be configured as or otherwise support a means for receiving the CA information via one or more CA pins of the memory system. In some examples, to support receiving the CA information, the error control component 330 may be configured as or otherwise support a means for receiving data associated with the CA information via one or more data pins of the memory system, where the data includes the error control information.

In some examples, to support performing the error control operation, the error control component 330 may be configured as or otherwise support a means for generating second error control information associated with the CA information. In some examples, to determine whether the CA information, the error control component 330 may be configured as or otherwise support a means for comparing the second error control information with the error control information and the error control component 330 may be configured as or otherwise support a means for determining whether the second error control information matches the error control information, where determining that the CA information includes the one or more errors is based at least in part on determining that the second error control information does not match the error control information.

In some examples, to support receiving the CA information, the CA component 325 may be configured as or otherwise support a means for receiving the CA information via one or more CA pins of the memory system. In some examples, to support receiving the CA information, the data component 340 may be configured as or otherwise support a means for receiving data associated with the CA information via one or more data pins of the memory system. In some examples, to support receiving the CA information, the error control component 330 may be configured as or otherwise support a means for receiving second error control information associated with the data via one or more error control pins of the memory system, where the second error control information includes the error control information.

In some examples, to support performing the operation, the feedback component 345 may be configured as or otherwise support a means for transmitting an indication that the CA information includes the one or more errors. In some examples, the access component 335 may be configured as or otherwise support a means for refraining from performing one or more operations associated with the CA information based at least in part on determining that the CA information includes one or more errors, where transmitting the indication is based at least in part on the refraining.

In some examples, the recovery component 350 may be configured as or otherwise support a means for receiving second CA information associated with the CA information and second error control information associated with the second CA information based at least in part on transmitting the indication. In some examples, to support performing the operation, the access component 335 may be configured as or otherwise support a means for performing one or more operations associated with the CA information based at least in part on determining that the CA information is free from the one or more errors.

In some examples, the described functionality of the memory system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 320, or various components thereof, may be implemented at least in part by instructions (e.g., stored in memory, non-transitory computer-readable medium) executable by such at least one processor.

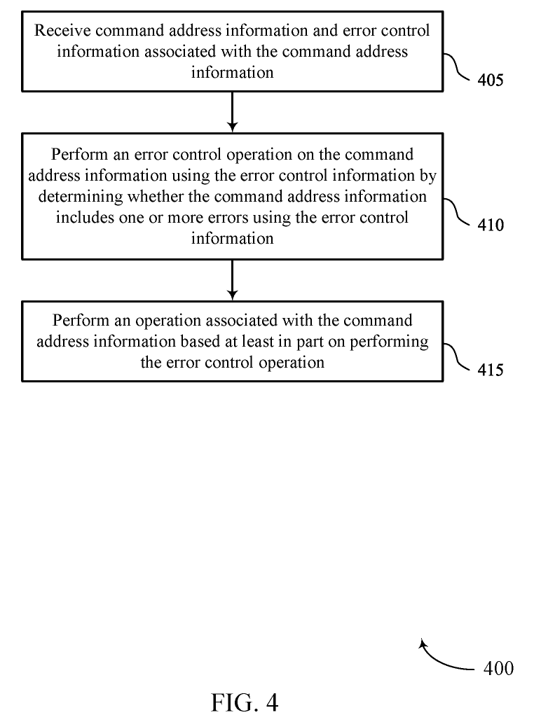

FIG. 4 shows a flowchart illustrating a method 400 that supports CA error control in accordance with examples as disclosed herein. The operations of method 400 may be implemented by a memory system or its components as described herein. For example, the operations of method 400 may be performed by a memory system as described with reference to FIGS. 1 through 3. In some examples, a memory system may execute a set of instructions to control the functional elements of the device to perform the described functions. Additionally, or alternatively, the memory system may perform aspects of the described functions using special-purpose hardware.

At 405, the method may include receiving CA information and error control information associated with the CA information. In some examples, aspects of the operations of 405 may be performed by a CA component 325 as described with reference to FIG. 3.

At 410, the method may include performing an error control operation on the CA information using the error control information by determining whether the CA information includes one or more errors using the error control information. In some examples, aspects of the operations of 410 may be performed by an error control component 330 as described with reference to FIG. 3.

At 415, the method may include performing an operation associated with the CA information based at least in part on performing the error control operation. In some examples, aspects of the operations of 415 may be performed by an access component 335 as described with reference to FIG. 3.

In some examples, an apparatus as described herein may perform a method or methods, such as the method 400. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving CA information and error control information associated with the CA information; performing an error control operation on the CA information using the error control information by determining whether the CA information includes one or more errors using the error control information; and performing an operation associated with the CA information based at least in part on performing the error control operation.

Aspect 2: The method, apparatus, or non-transitory computer-readable medium of aspect 1, where receiving the CA information includes operations, features, circuitry, logic, means, or instructions, or any combination thereof for receiving the CA information via one or more CA pins of the memory system and receiving the error control information via one or more pins of the memory system configured for receiving the error control information associated with the CA information.

Aspect 3: The method, apparatus, or non-transitory computer-readable medium of aspect 2, where receiving the CA information includes operations, features, circuitry, logic, means, or instructions, or any combination thereof for receiving data associated with the CA information via one or more data pins of the memory system and receiving second error control information associated with the data via one or more error control pins of the memory system.

Aspect 4: The method, apparatus, or non-transitory computer-readable medium of aspect 3, where performing the error control operation includes operations, features, circuitry, logic, means, or instructions, or any combination thereof for generating a codeword including the CA information and the data and generating third error control information associated with the CA information and the data, where determining whether the CA information includes the one or more errors includes comparing the third error control information with the error control information and the second error control information and determining whether the third error control information matches the error control information and the second error control information, where determining that the CA information includes the one or more errors is based at least in part on determining that the third error control information does not match the error control information and the second error control information.

Aspect 5: The method, apparatus, or non-transitory computer-readable medium of any of aspects 1 through 4, where receiving the CA information includes operations, features, circuitry, logic, means, or instructions, or any combination thereof for receiving the CA information via one or more CA pins of the memory system and receiving data associated with the CA information via one or more data pins of the memory system, where the data includes the error control information.

Aspect 6: The method, apparatus, or non-transitory computer-readable medium of any of aspects 1 through 5, where performing the error control operation includes operations, features, circuitry, logic, means, or instructions, or any combination thereof for generating second error control information associated with the CA information, where determining whether the CA information includes the one or more errors includes comparing the second error control information with the error control information and determining whether the second error control information matches the error control information, where determining that the CA information includes the one or more errors is based at least in part on determining that the second error control information does not match the error control information.

Aspect 7: The method, apparatus, or non-transitory computer-readable medium of any of aspects 1 through 6, where receiving the CA information includes operations, features, circuitry, logic, means, or instructions, or any combination thereof for receiving the CA information via one or more CA pins of the memory system; receiving data associated with the CA information via one or more data pins of the memory system; and receiving second error control information associated with the data via one or more error control pins of the memory system, where the second error control information includes the error control information.

Aspect 8: The method, apparatus, or non-transitory computer-readable medium of any of aspects 1 through 7, where performing the operation includes operations, features, circuitry, logic, means, or instructions, or any combination thereof for transmitting an indication that the CA information includes the one or more errors.

Aspect 9: The method, apparatus, or non-transitory computer-readable medium of aspect 8, further including operations, features, circuitry, logic, means, or instructions, or any combination thereof for refraining from performing one or more operations associated with the CA information based at least in part on determining that the CA information includes one or more errors, where transmitting the indication is based at least in part on the refraining.

Aspect 10: The method, apparatus, or non-transitory computer-readable medium of any of aspects 8 through 9, further including operations, features, circuitry, logic, means, or instructions, or any combination thereof for receiving second CA information associated with the CA information and second error control information associated with the second CA information based at least in part on transmitting the indication.

Aspect 11: The method, apparatus, or non-transitory computer-readable medium of any of aspects 1 through 10, where performing the operation further includes operations, features, circuitry, logic, means, or instructions, or any combination thereof for performing one or more operations associated with the CA information based at least in part on determining that the CA information is free from the one or more errors.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive command address information and error control information associated with the command address information;
perform an error control operation on the command address information using the error control information by determining whether the command address information comprises one or more errors using the error control information; and
perform an operation associated with the command address information based at least in part on performing the error control operation.

2. The memory system of claim 1, wherein receiving the command address information comprises the processing circuitry configured to cause the memory system to:
receive the command address information via one or more command address pins of the memory system; and
receive the error control information via one or more pins of the memory system configured for receiving the error control information associated with the command address information.

3. The memory system of claim 2, wherein receiving the command address information comprises the processing circuitry configured to cause the memory system to:
receive data associated with the command address information via one or more data pins of the memory system; and
receive second error control information associated with the data via one or more error control pins of the memory system.

4. The memory system of claim 3, wherein performing the error control operation comprises the processing circuitry configured to cause the memory system to:
generate a codeword comprising the command address information and the data; and
generate third error control information associated with the command address information and the data, wherein determine whether the command address information comprises the processing circuitry configured to cause the memory system to:
compare the third error control information with the error control information and the second error control information; and
determine whether the third error control information matches the error control information and the second error control information, wherein determining that the command address information comprises the one or more errors is based at least in part on determining that the third error control information does not match the error control information and the second error control information.

5. The memory system of claim 1, wherein receiving the command address information comprises the processing circuitry configured to cause the memory system to:
receive the command address information via one or more command address pins of the memory system; and
receive data associated with the command address information via one or more data pins of the memory system, wherein the data comprises the error control information.

6. The memory system of claim 1, wherein performing the error control operation comprises the processing circuitry configured to cause the memory system to:
generate second error control information associated with the command address information, wherein determine whether the command address information comprises the processing circuitry configured to cause the memory system to:
compare the second error control information with the error control information; and
determine whether the second error control information matches the error control information, wherein determining that the command address information comprises the one or more errors is based at least in part on determining that the second error control information does not match the error control information.

7. The memory system of claim 1, wherein receiving the command address information comprises the processing circuitry configured to cause the memory system to:
receive the command address information via one or more command address pins of the memory system;
receive data associated with the command address information via one or more data pins of the memory system; and
receive second error control information associated with the data via one or more error control pins of the memory system, wherein the second error control information comprises the error control information.

8. The memory system of claim 1, wherein performing the operation comprises the processing circuitry configured to cause the memory system to:
transmit an indication that the command address information comprises the one or more errors.

9. The memory system of claim 8, wherein the processing circuitry is further configured to cause the memory system to:
refrain from performing one or more operations associated with the command address information based at least in part on determining that the command address information comprises the one or more errors, wherein transmitting the indication is based at least in part on the refraining.

10. The memory system of claim 8, wherein the processing circuitry is further configured to cause the memory system to:
receive second command address information associated with the command address information and second error control information associated with the second command address information based at least in part on transmitting the indication.

11. The memory system of claim 1, wherein performing the operation further comprises the processing circuitry configured to cause the memory system to:
perform one or more operations associated with the command address information based at least in part on determining that the command address information is free from the one or more errors.

12. A method by a memory system, comprising:
receiving command address information and error control information associated with the command address information;
performing an error control operation on the command address information using the error control information by determining whether the command address information comprises one or more errors using the error control information; and
performing an operation associated with the command address information based at least in part on performing the error control operation.

13. The method of claim 12, wherein receiving the command address information comprises:
receiving the command address information via one or more command address pins of the memory system; and
receiving the error control information via one or more pins of the memory system configured for receiving the error control information associated with the command address information.

14. The method of claim 13, wherein receiving the command address information comprises:
receiving data associated with the command address information via one or more data pins of the memory system; and
receiving second error control information associated with the data via one or more error control pins of the memory system.

15. The method of claim 14, wherein performing the error control operation comprises:
generating a codeword comprising the command address information and the data; and
generating third error control information associated with the command address information and the data, wherein determining whether the command address information comprises the one or more errors comprises:
comparing the third error control information with the error control information and the second error control information; and
determining whether the third error control information matches the error control information and the second error control information, wherein determining that the command address information comprises the one or more errors is based at least in part on determining that the third error control information does not match the error control information and the second error control information.

16. The method of claim 12, wherein receiving the command address information comprises:
receiving the command address information via one or more command address pins of the memory system; and
receiving data associated with the command address information via one or more data pins of the memory system, wherein the data comprises the error control information.

17. The method of claim 12, wherein performing the error control operation comprises:
generating second error control information associated with the command address information, wherein determining whether the command address information comprises the one or more errors comprises:
comparing the second error control information with the error control information; and
determining whether the second error control information matches the error control information, wherein determining that the command address information comprises the one or more errors is based at least in part on determining that the second error control information does not match the error control information.

18. The method of claim 12, wherein receiving the command address information comprises:
receiving the command address information via one or more command address pins of the memory system;
receiving data associated with the command address information via one or more data pins of the memory system; and
receiving second error control information associated with the data via one or more error control pins of the memory system, wherein the second error control information comprises the error control information.

19. The method of claim 12, wherein performing the operation comprises:
transmitting an indication that the command address information comprises the one or more errors.

20. The method of claim 19, further comprising:
refraining from performing one or more operations associated with the command address information based at least in part on determining that the command address information comprises the one or more errors, wherein transmitting the indication is based at least in part on the refraining.

21. The method of claim 19, further comprising:
receiving second command address information associated with the command address information and second error control information associated with the second command address information based at least in part on transmitting the indication.

22. A non-transitory computer-readable medium storing code, the code comprising instructions executable by one or more processors to:
receive command address information and error control information associated with the command address information;
perform an error control operation on the command address information using the error control information by determining whether the command address information comprises one or more errors using the error control information; and
perform an operation associated with the command address information based at least in part on performing the error control operation.
